(19) United States
(12) Patent Application Publication
(10) Pub. No.: US 2019/0073880 A1
(43) Pub. Date: Mar. 7, 2019

(54) ARTICLE RECOGNITION APPARATUS, ARTICLE RECOGNITION METHOD, AND NON-TRANSITORY READABLE STORAGE MEDIUM

(71) Applicant: TOSHIBA TEC KABUSHIKI KAISHA, Tokyo (JP)

(72) Inventors: Tetsuya NOBUOKA, Sunto Shizuoka (JP); Masaaki YASUNAGA, Sunto Shizuoka (JP)

(21) Appl. No.: 15/697,185

(22) Filed: Sep. 6, 2017

(51) Int. Cl. G07G 1/00; G06Q 20/20; G06K 9/32; G06K 9/46; G06K 9/62

(52) U.S. Cl. CPC G07G 1/0063; G06Q 20/208; G06K 2009/6213; G06K 9/4609; G06K 9/6201; G06K 9/3241

(57) ABSTRACT

In general, according to one embodiment, an article recognition apparatus includes an image interface and a processor. The image interface acquires a captured image of a placing area where an article is placed. The processor acquires the captured image through the image interface, identifies a first article from the captured image, determines whether the first article overlaps a second article, if determining that the first article overlaps the second article, displays on a display device a warning screen that prompts movement of the first article to a position where the first article does not overlap another article, determines whether the first article is moved, and upon determining that the first article is moved, acquires a captured image through the image interface and identifies one or more articles from the captured image.

### FIELD

Embodiments described herein relate generally to an article recognition apparatus, an article recognition method, and a non-transitory readable storage medium.

### BACKGROUND

Some article recognition apparatuses recognize an article based on a captured image of the article placed on a stand. An article recognition apparatus identifies a region in which an article is placed from an image, and identifies the article in the region by reading a bar code, etc., or by object recognition, for example.

Conventionally, article recognition apparatuses have had a problem of being unable to recognize an article correctly if a plurality of articles are piled on top of the other.

### OBJECT OF INVENTION

To solve the aforementioned problem, an article recognition apparatus, an article recognition method, and a non-transitory readable storage medium that can properly recognize an article are provided.

### BRIEF DESCRIPTION OF THE DRAWINGS

FIG. 1 is a diagram schematically showing a configuration example of a checkout apparatus according to a first embodiment.

FIG. 2 is a block diagram showing a configuration example of the checkout apparatus according to the first embodiment.

FIG. 3A is a diagram showing an example of overlapping commodities according to the first embodiment.

FIG. 3B is a diagram showing an example of overlapping commodities according to the first embodiment.

FIG. 4A is a diagram showing an example of overlapping commodities according to the first embodiment.

FIG. 4B is a diagram showing an example of overlapping commodities according to the first embodiment.

FIG. 5A is a diagram showing an example of overlapping commodities according to the first embodiment.

FIG. 5B is a diagram showing an example of overlapping commodities according to the first embodiment.

FIG. 6A is a diagram showing examples of a warning screen according to the first embodiment.

FIG. 6B is a diagram showing examples of a warning screen according to the first embodiment.

FIG. 7A is a diagram showing examples of a recognition result screen according to the first embodiment.

FIG. 7B is a diagram showing examples of a recognition result screen according to the first embodiment.

FIG. 8 is a flow chart showing an operation example of the checkout apparatus according to the first embodiment.

FIG. 9A is a diagram showing an operation example of a checkout apparatus according to a second embodiment.

FIG. 9B is a diagram showing an operation example of a checkout apparatus according to a second embodiment.

FIG. 9C is a diagram showing an operation example of a checkout apparatus according to a second embodiment.

FIG. 10 is a flow chart showing an operation example of the checkout apparatus according to the second embodiment.

FIG. 11A is a diagram showing an operation example of a checkout apparatus according to a third embodiment.

FIG. 11B is a diagram showing an operation example of a checkout apparatus according to a third embodiment.

FIG. 11C is a diagram showing an operation example of a checkout apparatus according to a third embodiment.

FIG. 12 is a flow chart showing an operation example of the checkout apparatus according to the third embodiment.

FIG. 13 is a flow chart showing an operation example of the checkout apparatus according to the third embodiment.

### DETAILED DESCRIPTION

In general, according to one embodiment, an article recognition apparatus includes an image interface and a processor. The image interface acquires a captured image of a placing area where an article is placed. The processor acquires the captured image through the image interface, identifies a first article from the captured image, determines whether the first article overlaps a second article, if determining that the first article overlaps the second article, displays on a display device a warning screen that prompts movement of the first article to a position where the first article does not overlap another article, determines whether the first article is moved, and upon determining that the first article is moved, acquires a captured image through the image interface and identifies one or more articles from the captured image.

Hereinafter, embodiments will be described with reference to the accompanying drawings.

### First Embodiment

The first embodiment is described below.

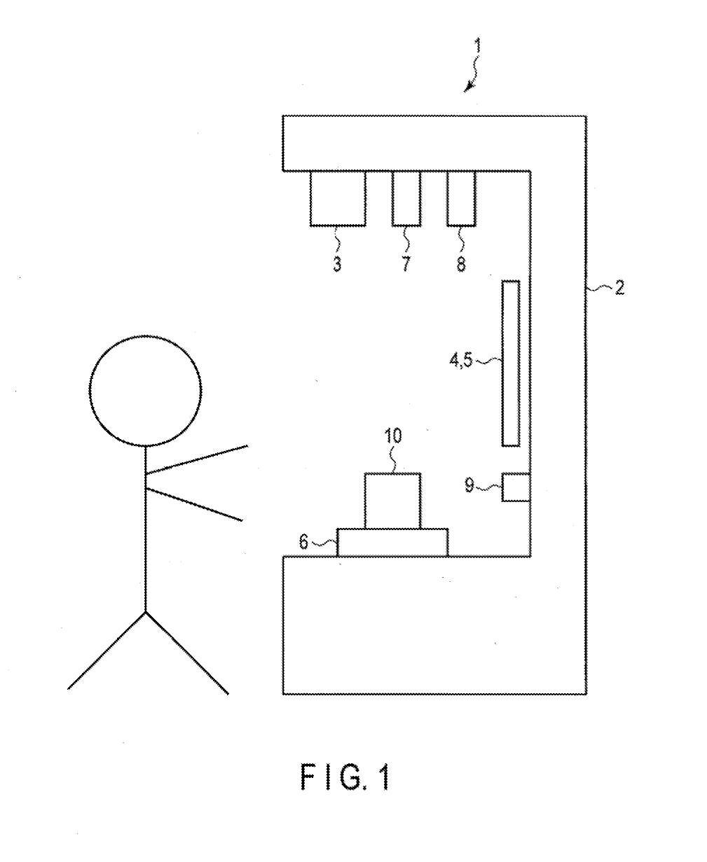

FIG. 1 schematically shows a configuration example of a checkout apparatus 1.

The checkout apparatus 1 (article recognition apparatus) settles payment for a commodity 10 (article). The checkout apparatus 1 is installed in a store, etc. that sells the commodity 10. For example, the checkout apparatus 1 settles the payment for the commodity 10 if the commodity 10 is placed at a predetermined position or if the checkout apparatus 1 receives a predetermined operation. The checkout apparatus 1 may be installed as a self-checkout machine with which a user makes payment by him or herself. The checkout apparatus 1 may also be installed as an ordinary cash register with which a sales clerk settles payment.

The checkout apparatus 1 includes a housing 2, camera 3, display 4, operation unit 5, placing stand 6, distance sensor 7, projector 8, speaker 9, etc., as shown in FIG. 1.

The housing 2 is a frame that forms a contour of the checkout apparatus 1. The housing 2 is formed to allow the commodity 10 to be placed thereon. In the example shown in FIG. 1, the housing 2 is U-shaped and is formed to allow the commodity 10 to be put thereon.

The camera 3 captures an image of the commodity 10 on the placing stand 6. In the example shown in FIG. 1, the camera 3 is installed so as to capture an image of the placing stand 6 from above. The camera 3 may be installed so as to capture an image of the placing stand 6 obliquely from above. The position where the camera 3 is installed and the direction of the camera 3 are not limited to specific ones.

The checkout apparatus 1 may include a plurality of cameras 3. In this case, the plurality of cameras 3 may be installed so as to capture an image of the commodity on the placing stand 6 at different positions and angles, respectively.

The camera 3 is a CCD camera, for example. The camera 3 may also be configured to capture an image of invisible light. The configuration of the camera 3 is not limited to a specific one.

The display 4 is a display device that displays an image output by a processor 21 described below. The display 4 is a liquid crystal monitor, for example.

Various operation instructions are input to the operation unit 5 by a user of the checkout apparatus 1. The operation unit 5 transmits, to the processor 21, data of the operation instruction input by the user. The operation unit 5 is a keyboard, numeric key, and touch panel, for example. The operation unit 5 may also receive gesture input from the user.

In this embodiment, the operation unit 5 is a touch panel and is formed integrally with the display 4.

The placing stand 6 is a stand on which the commodity 10 is placed. The placing stand 6 is arranged on the housing 2 to allow the user to place the commodity 10. The placing stand 6 may include a sensor that detects that the commodity 10 is placed. The sensor transmits a signal indicating that the commodity 10 is placed to the processor 21.

The distance sensor 7 is installed above the placing stand 6 in a manner facing downward. The distance sensor 7 measures a distance from a reference point or a reference surface (e.g., a distance from the distance sensor 7 or a distance from a surface horizontal to the distance sensor 7). For example, the distance sensor 7 measures a distance from the reference point or reference surface to the placing stand 6 or the commodity 10.

The distance sensor 7 generates distance information indicating a distance from the reference point or reference surface to each part on the placing stand 6. The distance information indicates a distance to the placing stand 6 or the commodity 10. For example, the distance information may be in the form of a distance image showing a different color depending on the distance.

The distance sensor 7 measures the distance based on, for example, a reflected light of a light (visible light or invisible light) emitted from a light source. For example, the distance sensor 7 may perform the TOF (Time-of-Flight) method in which a distance from an object to be measured is measured based on a time until the emitted light is reflected on the object to be measured and reaches the distance sensor 7. The distance sensor 7 may project a dot pattern and measure the distance based on the distortion of the projected dot pattern. The method for the distance sensor 7 to measure the distance is not limited to a specific one.

The checkout apparatus 1 may include a plurality of distance sensors.

The projector 8 is installed above the placing stand 6 in a manner facing downward. The projector 8 is a display device that projects an image onto the placing stand 6 or the commodity 10 according to a signal from the processor 21. The projector 8 projects an image or video generated by the processor 21 onto the placing stand 6 or the commodity 10.

The speaker 9 outputs a sound according to a signal from the processor 21. The speaker 9 outputs a sound so that the user who places the commodity 10 can hear the sound. In the example shown in FIG. 1, the speaker 9 is installed around the display 4 and the operation unit 5.

The camera 3, display 4, operation unit 5, placing stand 6, distance sensor 7, projector 8 or speaker 9 may be formed integrally with the housing 2.

The checkout apparatus 1 may also include a lighting device that lights the commodity 10, etc.

A configuration example of the checkout apparatus 1 is described below.

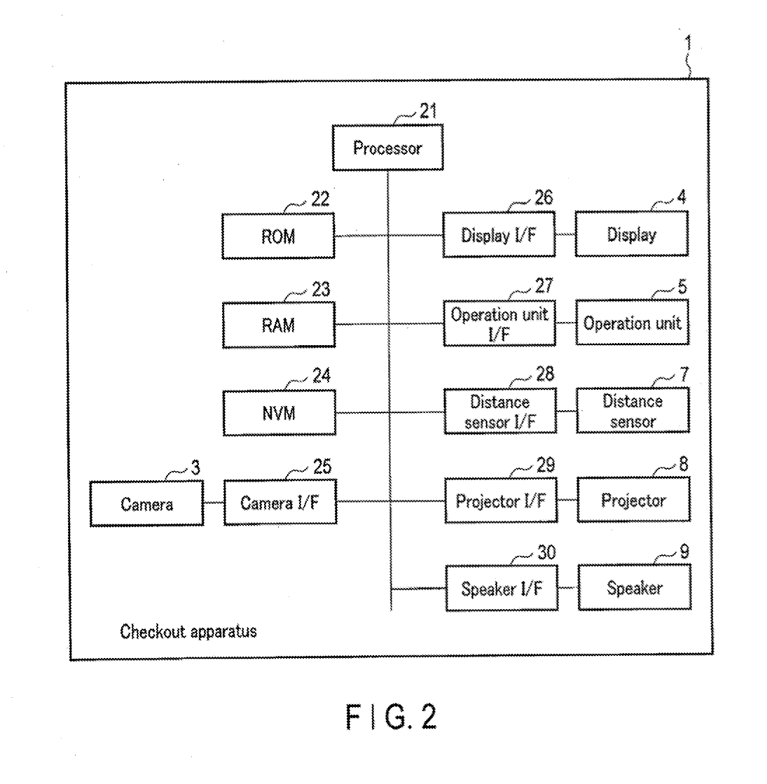

FIG. 2 is a block diagram showing the configuration example of the checkout apparatus 1.

The checkout apparatus 1 includes the camera 3, the display 4, the operation unit 5, the distance sensor 7, the projector 8, the speaker 9, the processor 21, a ROM 22, a RAM 23, an NVM 24, a camera interface 25, a display interface 26, an operation unit interface 27, a distance sensor interface 28, a projector interface 29, a speaker interface 30, etc., as shown in FIG. 2. The processor 21 is coupled with the ROM 22, RAM 23, NVM 24, camera interface 25, display interface 26, operation unit interface 27, distance sensor interface 28, projector interface 29, and speaker interface 30 via a data bus, etc.

The camera interface 25 and the camera 3 are coupled with each other via a data bus, etc. The display interface 26 and the display 4 are coupled with each other via a data bus, etc. The operation unit interface 27 and the operation unit 5 are coupled with each other via a data bus, etc. The distance sensor interface 28 and the distance sensor 7 are coupled with each other via a data bus, etc. The projector interface 29 and the projector 8 are coupled with each other via a data bus, etc. The speaker interface 30 and the speaker 9 are coupled with each other via a data bus, etc.

The checkout apparatus 1 may include a structure as needed, other than the structure shown in FIG. 2, or may remove a specific structure.

The camera 3, display 4, operation unit 5, distance sensor 7, projector 8 and speaker 9 are as described above.

The processor 21 functions to control operation of the entire checkout apparatus 1. The processor 21 may include an inner memory, various interfaces, etc. The processor 21 implements various kinds of processing by executing a program stored in advance in the inner memory, ROM 22, NVM 24, or the like. The processor 21 is a CPU, for example.

Some of the various functions fulfilled by the processor 21 by executing the program may be performed by a hardware circuit. In this case, the processor 21 controls the functions performed by the hardware circuit.

The ROM 22 is a non-volatile memory that stores a control program, control data, etc., in advance. The ROM 22 is loaded into the checkout apparatus 1 in a manufacturing stage in the state of storing the control program, control data, etc. Namely, the control program and the control data stored in the ROM 22 are preloaded according to the specification of the checkout apparatus 1.

The RAM 23 is a volatile memory. The RAM 23 temporarily stores data, etc., during processing at the processor 21. The RAM 23 stores various application programs based on an instruction from the processor 21. The RAM 23 may also store data necessary for executing an application program and an execution result of the application program, etc.

The NVM 24 (non-transitory readable storage medium) is a non-volatile memory on which data may be written and rewritten. The NVM 24 is formed of an HDD (Hard Disk Drive), SSD (Solid State Drive), EEPROM (registered trademark), or flash memory, for example. The NVM 24 stores a control program, an application, various data, etc., in accordance with the operation purpose of the checkout apparatus 1.

The NVM 24 stores commodity information. The commodity information is information on commodities. The commodity information is stored in association with a commodity code, dictionary information, and outer size of a commodity.

The commodity code is information for identifying a commodity. For example, the commodity code includes a number, letter, symbol, or a combination thereof.

The dictionary information is information for identifying the commodity 10 in a commodity region by comparing the commodity 10 with an image of the commodity region. For example, the dictionary information is an image of a commodity, a feature amount of the image of the commodity, or the like. For example, the feature amount is a concentration gradient, color histogram, or the like.

The outer size of a commodity is a length of each surface of the commodity. Namely, the outer size of a commodity is a height from a predetermined surface to a top surface of the commodity when the commodity is put on the predetermined surface. For example, the outer size of a commodity is a height from the predetermined surface on which the commodity is put to the highest position.

The commodity information may further include an area of each surface of a commodity, a commodity name, a price, etc. The configuration of the commodity information is not limited to a specific one.

The NVM 24 stores the commodity information on each commodity in advance. For example, the processor 21 receives the commodity information from an external device and stores the commodity information in the NVM 24. Also, the commodity information may be updated, as appropriate.

The camera interface 25 (image interface) is an interface for the processor 21 to communicate with the camera 3. For example, the processor 21 transmits a signal to acquire an image to the camera 3 through the camera interface 25. The processor 21 may also set a camera parameter for capturing an image in the camera 3 through the camera interface 25.

Also, the camera interface 25 acquires an image captured by the camera 3. The camera interface 25 transmits the acquired image to the processor 21. The processor 21 acquires the image captured by the camera 3 from the camera interface 25.

The display interface 26 is an interface for the processor 21 to communicate with the display 4. For example, the processor 21 transmits a display screen to the display 4 through the display interface 26.

The operation unit interface 27 is an interface for the processor 21 to communicate with the operation unit 5. For example, the processor 21 receives a signal indicating an operation input to the operation unit 5 through the operation unit interface 27.

The distance sensor interface 28 (distance information interface) is an interface for the processor 21 to communicate with the distance sensor 7. For example, the processor 21 acquires distance information from the distance sensor 7 through the distance sensor interface 28.

The projector interface 29 is an interface for the processor 21 to communicate with the projector 8. For example, the processor 21 transmits, to the projector 8 through the projector interface 29, a projection image to be projected by the projector 8.

The speaker interface 30 is an interface for the processor 21 to communicate with the speaker 9. For example, the processor 21 transmits a signal to output a warning sound, etc. to the speaker 9 through the speaker interface 30.

Functions fulfilled by the processor 21 are described below. The functions described below are fulfilled by the processor 21 executing the program stored in the NVM 24, etc.

The processor 21 functions to acquire a captured image of a predetermined place where the commodity 10 is placed. In this embodiment, the processor 21 acquires a captured image of the commodity 10 placed on the placing stand 6.

For example, the processor 21 detects that the commodity 10 is placed on the placing stand 6 by a user. For example, the processor 21 detects that the commodity 10 is placed on the placing stand 6 based on a signal from the placing stand 6. The processor 21 may detect that the commodity 10 is placed on the placing stand 6 based on the image from the camera 3. The processor 21 may also receive, from a user, an operation indicating that the commodity 10 is placed on the placing stand 6.

Upon detecting that the commodity 10 is placed, the processor 21 captures an image including the commodity 10. For example, the processor 21 transmits a signal to capture an image to the camera 3. The processor 21 acquires a captured image from the camera 3. The processor 21 may set an image capture parameter in the camera 3 in order to capture an image.

The processor 21 may acquire a captured image from an external device.

The processor 21 also functions to acquire distance information from the distance sensor 7.

For example, the processor 21 transmits, to the distance sensor 7, a signal to measure a distance. The processor 21 acquires distance information from the distance sensor 7.

The processor 21 also functions to extract a commodity region that shows a commodity from the captured image.

The processor 21 extracts the commodity region based on the captured image. For example, the processor 21 performs edge detection, etc., to extract the commodity region from the captured image.

The processor 21 may also extract the commodity region based on the distance information. The region where the commodity 10 is placed (commodity region) approaches the reference point or reference surface by the height of the commodity 10. Accordingly, the processor 21 specifies, as the commodity region, a region at a distance shorter than the distance to the placing stand 6.

The processor 21 may also extract the commodity region based on the captured image and the distance information.

The method for the processor 21 to extract the commodity region is not limited to a specific one.

The processor 21 also functions to identify the commodity 10 (first article) in the commodity region.

For example, if the commodity 10 includes identification information that identifies the commodity 10, the processor 21 identifies the commodity based on the identification information. For example, the identification information is a bar code, QR code (registered trademark), letter, number, mark, or the like. The processor 21 retrieves the identification information from a commodity image and reads discovered identification information. The processor 21 acquires a commodity code that indicates the commodity in the commodity image based on a read-out result.

The processor 21 may also identify the commodity 10 by object recognition. The processor 21 acquires dictionary information of each piece of commodity information from the NVM 24, etc.

For example, the processor 21 compares the dictionary information and the image of the commodity region. The processor 21 identifies the commodity code in the commodity information that corresponds to the dictionary information matching the image of the commodity region, as the commodity code indicating the commodity in the commodity image.

The method for the processor 21 to identify the commodity is not limited to a specific one.

The processor 21 also functions to acquire the outer size preset in the identified commodity 10.

For example, the processor 21 acquires, from the NVM 24, the commodity information including the commodity code of the identified commodity. The processor 21 acquires, as the preset outer size, the outer size included in the acquired commodity information. The processor 21 may acquire the outer size of the commodity from an external device.

The processor 21 also functions to determine whether the identified commodity 10 overlaps with another commodity (second article) based on the outer size preset in the commodity.

The processor 21 calculates the difference between the distance to the placing stand 6 and the distance to the commodity region based on the distance information, to calculate the height of the commodity 10 placed in the commodity region.

The processor 21 compares the height and the preset outer size of the commodity 10. The processor 21 determines which surface of the commodity faces upward, and compares the outer size between the surface facing upward and a surface opposite thereto and the height of the commodity.

The processor 21 determines whether the height and the preset outer size of the commodity 10 match each other. If the difference between the height and the outer size of the commodity 10 is not greater than a certain threshold, the processor 21 may determine that the height and the outer size of the commodity 10 match each other.

Upon determining that the height and the preset outer size of the commodity 10 match each other, the processor 21 determines that the commodity 10 does not overlap with another commodity. Also, upon determining that the height and the preset outer size of the commodity 10 do not match each other, the processor 21 determines that the commodity 10 overlaps with another commodity.

The processor 21 may determine whether the commodity 10 overlaps with another commodity based on the area of the commodity region and the preset area of the commodity 10. For example, if the area of the commodity region is larger than the preset area, the processor 21 determines that the commodity 10 overlaps with another commodity.

An example of overlapping commodities 10 is described below.

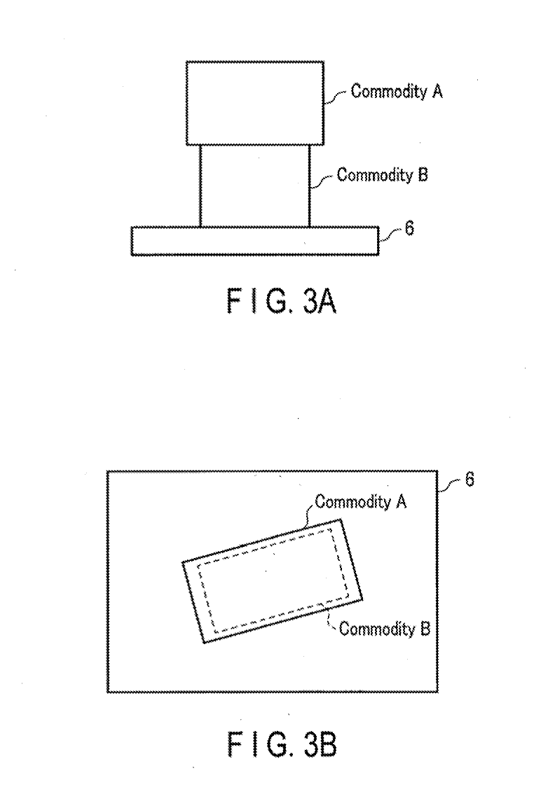

FIG. 3 shows an example in which the commodities 10 are piled on top of the other on the placing stand 6. FIG. 3A is a lateral view of the placing stand 6. FIG. 3B is a top view of the placing stand 6.

A commodity A is placed on a commodity B, as shown in FIG. 3. Also, the commodity A is larger than the commodity B, covering the commodity B. Therefore, the commodity B is not shown in a captured image. Consequently, the processor 21 cannot identify the commodity B.

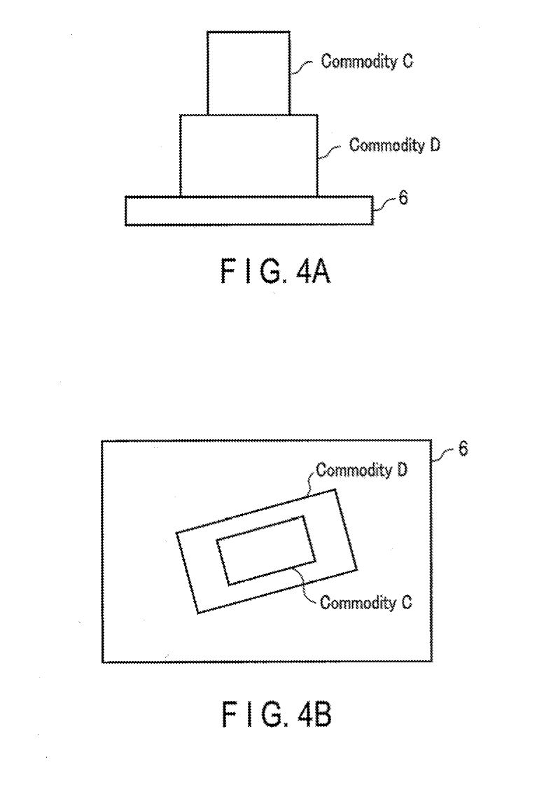

FIG. 4 shows another example in which the commodities 10 are piled on top of the other on the placing stand 6. FIG. 4A, like FIG. 3, is a lateral view of the placing stand 6. FIG. 4B is a top view of the placing stand 6.

A commodity C is placed on a commodity D, as shown in FIG. 4. Also, the commodity C is smaller than the commodity D. Therefore, a part of the commodity D is shown in a captured image. However, the accuracy of identifying the commodity D decreases due to insufficient information of the commodity D.

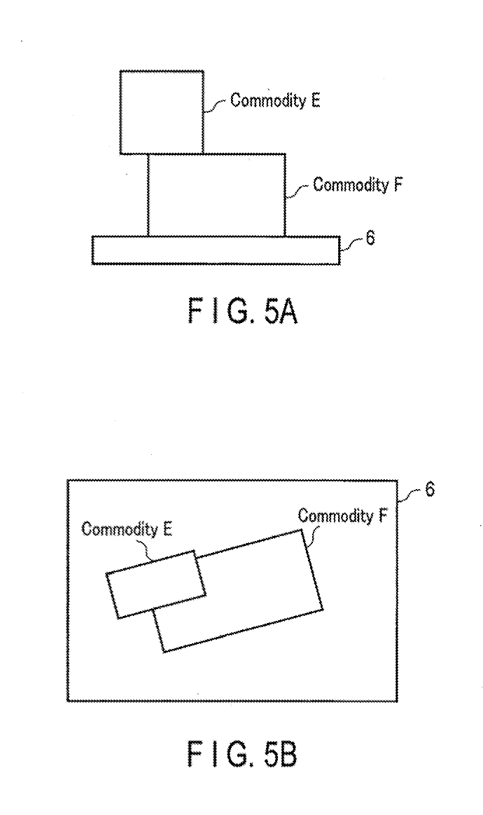

FIG. 5 shows another example in which the commodities 10 are piled on top of the other on the placing stand 6. FIG. 5A, like FIG. 3, is a lateral view of the placing stand 6. FIG. 5B is a top view of the placing stand 6.

A commodity E is placed on a commodity F, as shown in FIG. 5. Also, the commodity E is far smaller than the commodity F. Therefore, most of the commodity F is shown in a captured image. Accordingly, the processor 21 may be able to identify the commodity F. However, if there is another commodity under the commodity E, the processor 21 cannot identify the commodity F.

Also, if the identified commodity 10 overlaps with another commodity, the processor 21 functions to prompt movement of the identified commodity 10 to a position on the placing stand 6.

The processor 21 generates a warning screen that is displayed on the placing stand 6 through the projector 8. The warning screen prompts a user to move the commodity 10 to a position on the placing stand 6. The warning screen indicates that the commodity 10 overlaps with another commodity, and indicates where to move the commodity 10, etc. In this embodiment, the warning screen is an image showing that the commodity 10 overlaps with another commodity and a sequence of images showing where to move the commodity 10, etc.

The processor 21 generates, as the warning screen, a projection mapping image that is projected to the placing stand 6. For example, the processor 21 generates, as the warning screen, an animation, etc. in which the identified commodity 10 is moved.

The processor 21 displays the generated warning screen on the placing stand 6 through the projector 8.

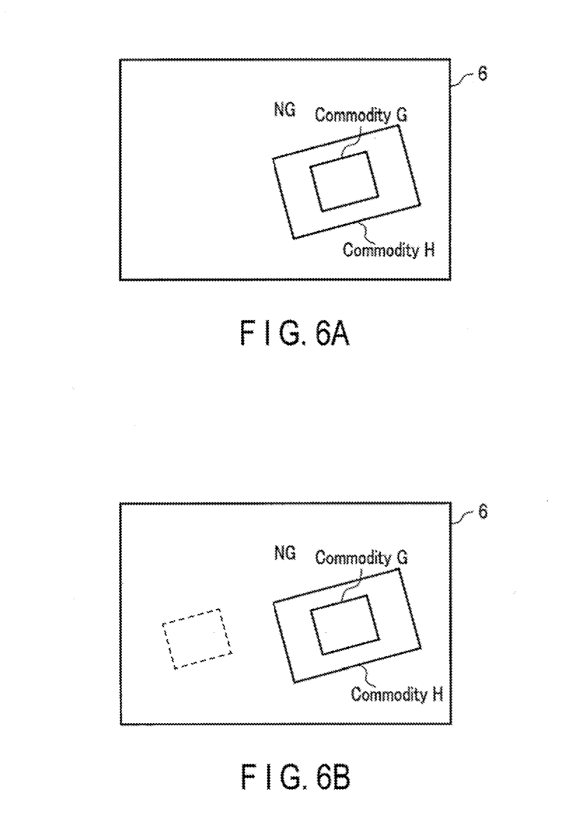

FIG. 6 is a diagram showing examples of the warning screen. In this diagram, a commodity G and commodity H are placed on the placing stand 6. Also, the commodity G is placed on the commodity H. The processor 21 identifies the commodity G.

FIG. 6A shows an example of the warning screen showing that the commodities overlap each other. FIG. 6B shows an example of the warning screen showing where to move the commodity to.

The warning screen shown in FIG. 6A indicates that the commodity G overlaps with another commodity. The warning screen displays “NG” to indicate that the commodity G overlaps with another commodity.

The warning screen shown in FIG. 6B indicates where to move the commodity G. The warning screen displays an arrow overlapping the commodity G. The warning screen prompts movement of the commodity G to a position pointed to by the arrow. The warning screen may be an animation. For example, the warning screen may be an animation in which the commodity G moves to a predetermined position.

The processor 21 may display the warning screen shown in FIG. 6B after displaying the warning screen shown in FIG. 6A. The processor 21 may also display both of the warning screens alternately.

The content of the warning screen is not limited to a specific configuration.

The processor 21 may also output an audio message that prompts movement of the commodity 10 through the speaker 9.

The processor 21 may also display, on the display 4, a message that prompts movement of the commodity 10.

The processor 21 also functions to detect that the identified commodity 10 is moved.

Upon projecting the warning screen, the processor 21 determines whether the identified commodity 10 is moved by a user. For example, the processor 21 determines whether the identified commodity 10 is moved based on the captured image from the camera 3.

The processor 21 may also determine whether a user touches the commodity 10 based on the distance information. If determining that the user touches the commodity 10, the processor 21 determines that the commodity 10 is moved.

The processor 21 may also receive, from the user, an operation indicating that the commodity 10 is moved through the operation unit 5.

The method for the processor 21 to detect the movement of the commodity 10 is not limited to a specific one.

The processor 21 also functions to present the information on the identified commodity 10.

The processor 21 generates a recognition result screen that is displayed on the placing stand 6 through the projector 8. The recognition result screen shows the user that the commodity 10 on the placing stand 6 is successfully identified, and shows the user the information on the commodity 10, etc.

For example, the processor 21 acquires the commodity information including the commodity code of the identified commodity, and generates the recognition result screen based on the commodity information, etc.

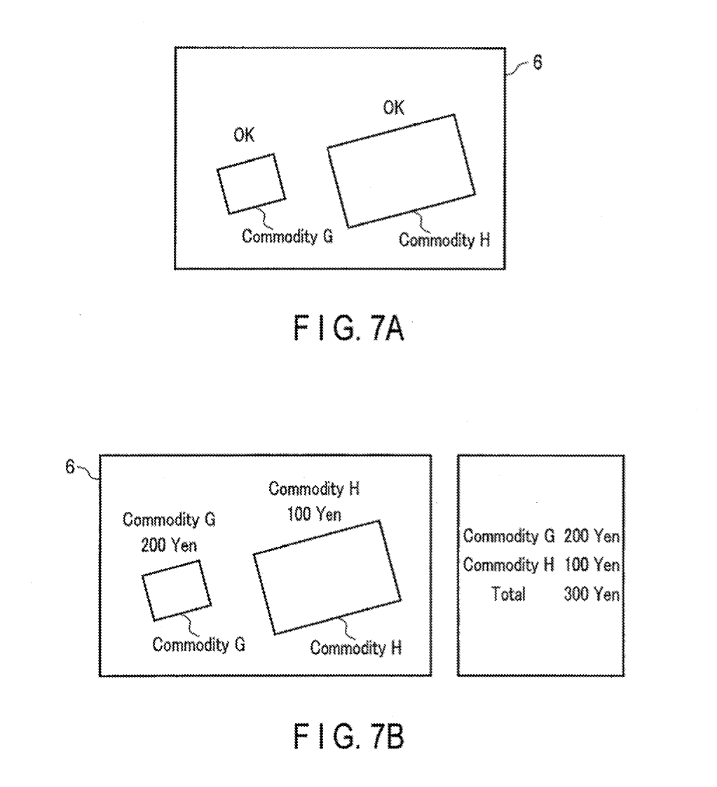

FIG. 7 is a diagram showing examples of the recognition result screen. In this diagram, the commodity G and the commodity H are placed on the placing stand 6. The processor 21 identifies the commodities G and H.

FIG. 7A shows an example of the recognition result screen showing that the commodity 10 is successfully identified. FIG. 7B shows an example of the recognition result screen that displays information of the commodity 10.

The recognition result screen shown in FIG. 7A shows that the commodities G and H are identified. Namely, the recognition result screen shows that there is no commodity overlapping with another commodity. The recognition result screen displays “OK” around each of the commodities G and H, to indicate that the commodities G and H are identified.

The recognition result screen shown in FIG. 7B shows information on the commodities G and H. The recognition result screen shows the commodity names and the price of the commodities G and H. The recognition result screen also shows the total price of the commodities G and H.

The processor 21 may display the recognition result screen shown in FIG. 7B after displaying the recognition result screen shown in FIG. 7A. The processor 21 may also display both of the recognition result screens alternately.

The content of the recognition result screen is not limited to a specific configuration.

The processor 21 also functions to settle the payment for the identified commodity 10.

The processor 21 acquires the price from the commodity information of the identified commodity 10, etc. The processor 21 may also acquire the price of the identified commodity 10 from an external device.

The processor 21 settles the payment for the commodity based on the price of the commodity. For example, the processor 21 receives input of credit card information from the user. For example, the processor 21 may acquire credit card information by using a credit card reader, etc. The processor 21 settles the payment for the commodity based on the credit card information.

The processor 21 may also settle the payment for the commodity with cash, a debit card, electronic money, or the like. The method for the processor 21 to settle the payment for the commodity is not limited to a specific one.

An operation example of the checkout apparatus 1 is described below.

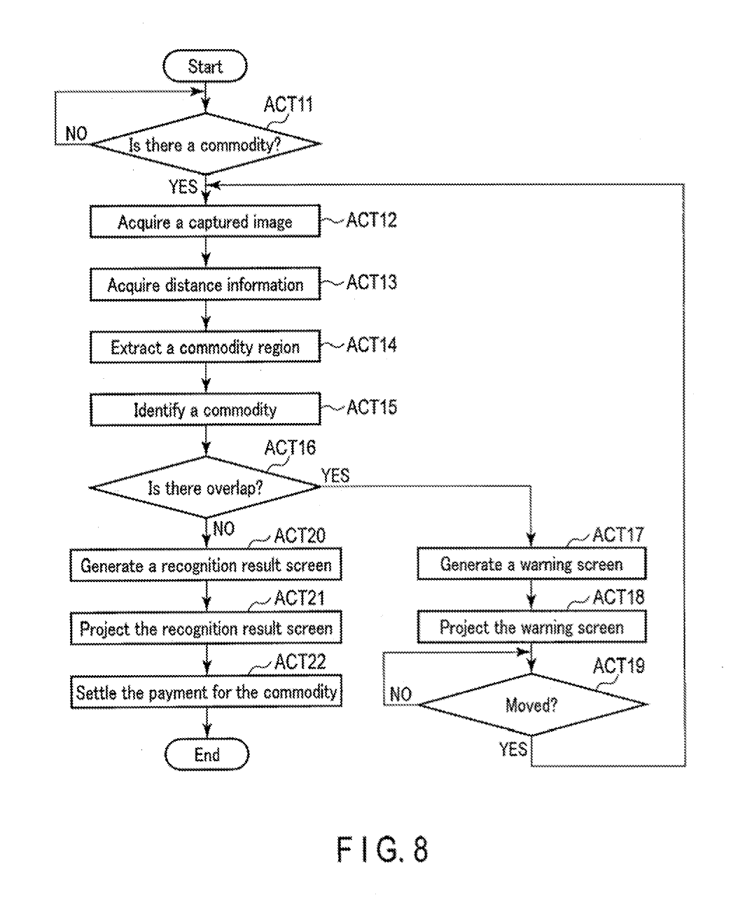

FIG. 8 is a flow chart illustrating an operation example of the checkout apparatus 1.

First, the processor 21 of the checkout apparatus 1 determines whether the commodity 10 is placed on the placing stand 6 (ACT 11). Upon determining that the commodity 10 is not placed on the placing stand 6 (ACT 11, NO), the processor 21 returns to ACT 11.

Upon determining that the commodity 10 is placed on the placing stand 6 (ACT 11, YES), the processor 21 acquires a captured image of the commodity 10 through the camera 3 (ACT 12). Upon acquiring the captured image, the processor 21 acquires distance information from the distance sensor 7 (ACT 13).

Upon acquiring the distance information, the processor 21 extracts a commodity region from the captured image (ACT 14). Upon extracting the commodity region, the processor 21 identifies the commodity 10 in the commodity region (ACT 15).

Upon identifying the commodity 10, the processor 21 determines whether the identified commodity 10 overlaps with another commodity (ACT 16). Upon determining that the identified commodity 10 overlaps with another commodity (ACT 16, YES), the processor 21 generates a warning screen that prompts movement of the commodity 10 (ACT 17).

Upon generating the warning screen, the processor 21 projects the generated warning screen onto the placing stand 6 through the projector 8 (ACT 18). Upon projecting the warning screen, the processor 21 determines whether the identified commodity 10 is moved (ACT 19).

Upon determining that the identified commodity 10 is not moved (ACT 19, NO), the processor 21 returns to ACT 19. The processor 21 may keep projecting the warning screen.

Upon determining that the identified commodity 10 is moved (ACT 19, YES), the processor 21 returns to ACT 12.

Upon determining that the identified commodity 10 does not overlap with another commodity (ACT 16, NO), the processor 21 generates a recognition result screen concerning the identified commodity 10 (ACT 20). Upon generating the recognition result screen, the processor 21 projects the generated recognition result screen onto the placing stand 6 through the projector 8 (ACT 21).

Upon projecting the generated recognition result screen onto the placing stand 6, the processor 21 settles the payment for the identified commodity 10 (ACT 22). Upon settling the payment for the identified commodity 10, the processor 21 ends the operation.

If determining that a plurality of commodities 10 overlap with another commodity, the processor 21 may project a warning screen that prompts movement of each commodity 10.

The checkout apparatus having the above-described configuration detects that commodities are piled on top of the other. If the commodities overlap each other, the checkout apparatus prompts movement of a commodity placed at the top to a position on the placing stand. Once the commodity is moved, the checkout apparatus identifies a commodity again.

As a result, the checkout apparatus can identify the commodities in a state where the commodities do not overlap each other. Accordingly, the checkout apparatus can identify the commodities properly.

### Second Embodiment

The second embodiment is described below.

A checkout apparatus 1 of the second embodiment is different from that of the first embodiment in that the checkout apparatus 1 of the second embodiment prompts removal of the commodity 10 overlapping with another commodity if there is no place to which to move the overlapping commodity 10. Therefore, the other features are indicated by the same symbols, and detailed description thereof is omitted.

Since the configuration of the checkout apparatus 1 of the second embodiment is the same as that of the first embodiment, description thereof is omitted.

Functions fulfilled by the processor 21 are described below. The functions described below are fulfilled by the processor 21 executing the program stored in the NVM 24, etc.

Also, if the identified commodity 10 overlaps with another commodity, the processor 21 functions to determine whether there is a place to which to move the identified commodity 10.

For example, the processor 21 determines whether there is a place to which to move the identified commodity 10 based on, for example, the shape and the area of the commodity region of the identified commodity 10. The processor 21 determines a region other than the commodity region as a region that shows the placing stand 6. The processor 21 determines whether the region that shows the placing stand 6 has a space to include the commodity region of the identified commodity 10. If the region does not have the space, the processor 21 determines that there is no place to which to move the identified commodity 10.

Also, if there is no place to which to move the identified commodity 10, the processor 21 functions to prompt removal of the identified commodity 10.

The processor 21 generates a warning screen that is displayed on the placing stand 6 through the projector 8. The warning screen prompts a user to remove the commodity 10. The warning screen shows that the commodity 10 overlaps with another commodity, and shows removal of the commodity 10, etc. In this embodiment, the warning screen is an image showing that the commodity 10 overlaps with another commodity and a sequence of images that prompts removal of the commodity 10.

The processor 21 generates, as the warning screen, a projection mapping image that is projected to the placing stand 6. For example, the processor 21 generates, as the warning screen, an animation, etc. in which the identified commodity 10 is removed.

The processor 21 displays the generated warning screen on the placing stand 6 through the projector 8.

The content of the warning screen is not limited to a specific configuration.

The processor 21 may also output an audio message that prompts removal of the commodity 10 through the speaker 9.

The processor 21 may also display, on the display 4, a message that prompts removal of the commodity 10.

The processor 21 also functions to detect that the identified commodity 10 is removed.

Upon projecting the warning screen, the processor 21 determines whether the identified commodity 10 is removed by a user. For example, the processor 21 determines whether the identified commodity 10 is removed based on the captured image from the camera 3.

The processor 21 may also determine whether a user touches the commodity 10 based on the distance information. If determining that the user touches the commodity 10, the processor 21 determines that the commodity 10 is removed.

The processor 21 may also receive, from the user, an operation indicating that the commodity 10 is removed through the operation unit 5.

The method for the processor 21 to detect the removal of the commodity 10 is not limited to a specific one.

Upon determining that the identified commodity 10 is removed, the processor 21 acquires a captured image to identify another commodity. Also, upon identifying another commodity, the processor 21 prompts placement of the commodity 10 identified first, and identifies the commodity 10 again.

An operation example in which the checkout apparatus 1 identifies a commodity is described below.

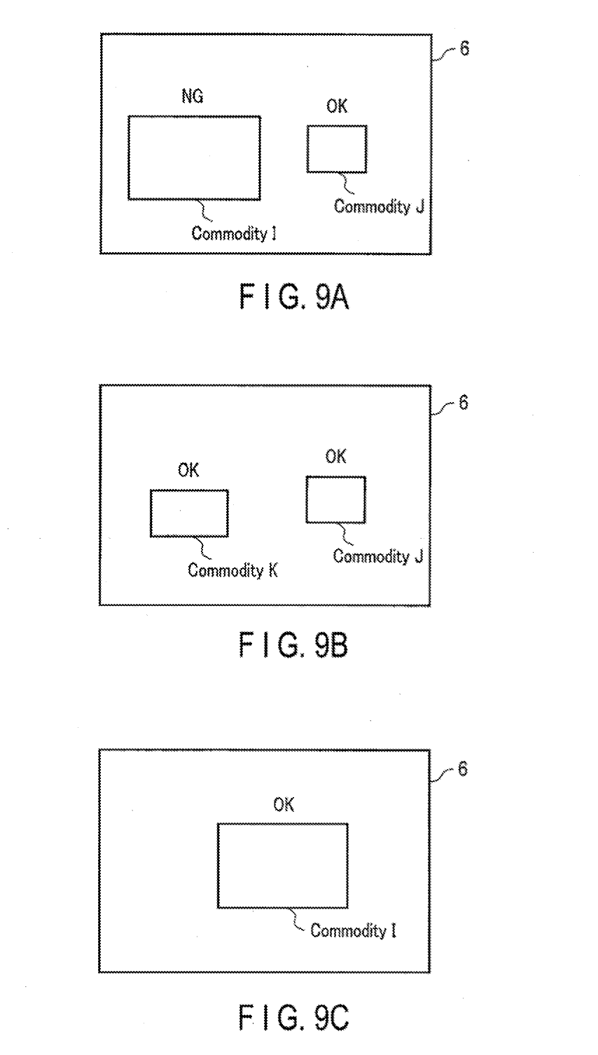

FIG. 9 is a diagram illustrating an operation example in which the checkout apparatus 1 identifies a commodity. In the example shown in FIG. 9, commodities I, J and K are placed on the placing stand 6. Also, the commodity I is placed on the commodity K.

First, the processor 21 of the checkout apparatus 1 identifies the commodities on the placing stand 6. In this example, the processor 21 identifies the commodities I and J, as shown in FIG. 9A.

The processor 21 determines that the commodity I overlaps another commodity (commodity K, in this example). Therefore, the processor 21 displays “NG” near the commodity I. The processor 21 displays, near the commodity J, “OK” indicating that the commodity J does not overlap with another commodity.

The processor 21 projects a warning screen to remove the commodity I. In this example, a user removes the commodity I according to the warning screen.

Upon detecting that the commodity I is removed, the processor 21 identifies the commodities K and J. The processor 21 identifies the commodities K and J, and displays “OK” near each commodity, as shown in FIG. 9B.

Upon identifying the commodities K and J, the processor 21 prompts the user to place the commodity I. In this example, the user places the commodity I.

The processor 21 identifies the placed commodity I. The processor 21 identifies the commodity I and displays “OK” near the commodity I, as shown in FIG. 9C.

An operation example of the checkout apparatus 1 is described below.

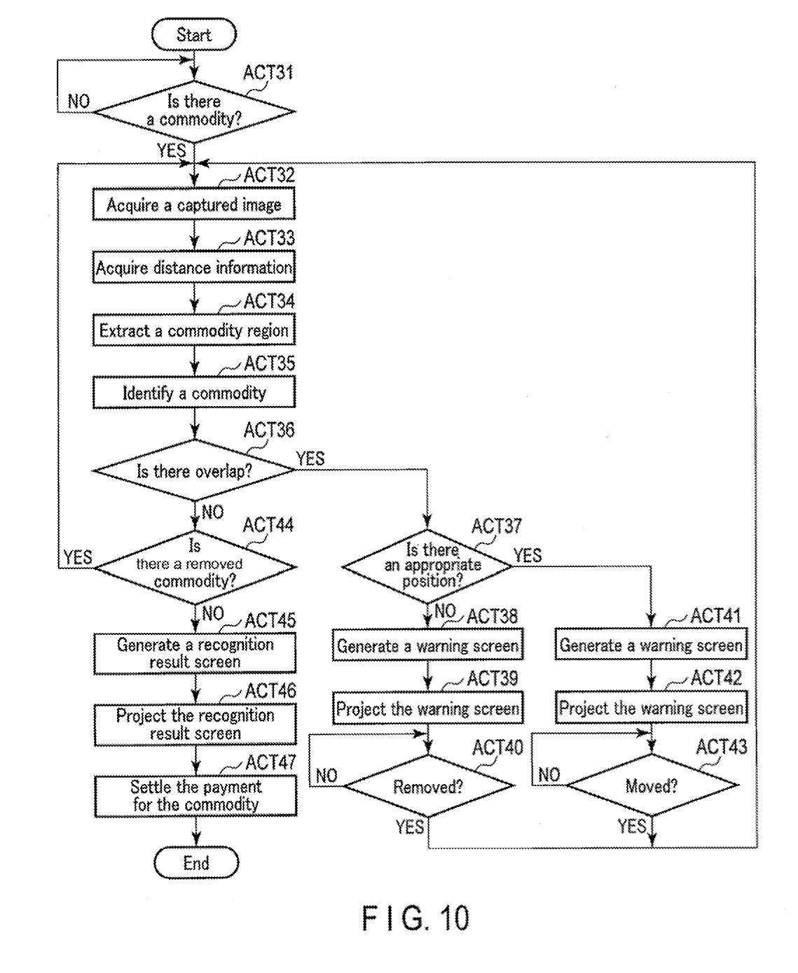

FIG. 10 is a flow chart illustrating an operation example of the checkout apparatus 1.

First, the processor 21 of the checkout apparatus 1 determines whether the commodity 10 is placed on the placing stand 6 (ACT 31). Upon determining that the commodity 10 is not placed on the placing stand 6 (ACT 31, NO), the processor 21 returns to ACT 31.

Upon determining that the commodity 10 is placed on the placing stand 6 (ACT 31, YES), the processor 21 acquires a captured image of the commodity 10 through the camera 3 (ACT 32). Upon acquiring the captured image, the processor 21 acquires distance information from the distance sensor 7 (ACT 33).

Upon acquiring the distance information, the processor 21 extracts a commodity region from the captured image (ACT 34). Upon extracting the commodity region, the processor 21 identifies the commodity 10 in the commodity region (ACT 35).

Upon identifying the commodity 10, the processor 21 determines whether the identified commodity 10 overlaps with another commodity (ACT 36). Upon determining that the identified commodity 10 overlaps with another commodity (ACT 36, YES), the processor 21 determines whether there is a place to which to move the identified commodity 10 (ACT 37).

Upon determining that there is no place to which to move the identified commodity 10 (ACT 37, NO), the processor 21 generates a warning screen that prompts removal of the identified commodity 10 (ACT 38). Upon generating the warning screen, the processor 21 projects the generated warning screen through the projector 8 (ACT 39).

Upon projecting the warning screen, the processor 21 determines whether the identified commodity 10 is removed (ACT 40). Upon determining that the identified commodity 10 is not removed (ACT 40, NO), the processor 21 returns to ACT 40. The processor 21 may keep projecting the warning screen.

Upon determining that the identified commodity 10 is removed (ACT 40, YES), the processor 21 returns to ACT 32.

Upon determining that there is a place to which to move the identified commodity 10 (ACT 37, YES), the processor 21 generates a warning screen that prompts movement of the identified commodity 10 (ACT 41).

Upon generating the warning screen, the processor 21 projects the generated warning screen onto the placing stand 6 through the projector 8 (ACT 42). Upon projecting the warning screen, the processor 21 determines whether the identified commodity 10 is moved (ACT 43).

Upon determining that the identified commodity 10 is not moved (ACT 43, NO), the processor 21 returns to ACT 43. The processor 21 may keep projecting the warning screen.

Upon determining that the identified commodity 10 is moved (ACT 43, YES), the processor 21 returns to ACT 32.

Upon determining that the identified commodity 10 does not overlap with another commodity (ACT 36, NO), the processor 21 determines whether there is a removed commodity 10 (ACT 44). Upon determining that there is a removed commodity 10 (ACT 44, YES), the processor 21 returns to ACT 32. The processor 21 may display a message that prompts placement of the removed commodity 10 on the placing stand 6, etc.

Upon determining that there is no removed commodity 10 (or identification of the removed commodity 10 is completed) (ACT 44, NO), the processor 21 generates a recognition result screen related to the identified commodity 10 (ACT 45). Upon generating the recognition result screen, the processor 21 projects the generated recognition result screen onto the placing stand 6 through the projector 8 (ACT 46).

Upon projecting the generated recognition result screen onto the placing stand 6, the processor 21 settles the payment for the identified commodity 10 (ACT 47). Upon settling the payment for the identified commodity 10, the processor 21 ends the operation.

If determining that a plurality of commodities overlap another commodity, the processor 21 may prompt removal of the plurality of commodities. The processor 21 may also prompt placement of the removed commodities after identifying the commodity placed at the bottom.

The checkout apparatus having the above-described configuration prompts removal of a commodity if there is no place to which to move the commodity on the placing stand. Once the commodity is removed, the checkout apparatus identifies a commodity again.

As a result, even if there is no place to which to move the commodity on the placing stand, the checkout apparatus can identify commodities in the state where the commodities do not overlap each other.

### Third Embodiment

The third embodiment is described below.

The checkout apparatus 1 of the third embodiment is different from that of the second embodiment in that the checkout apparatus 1 of the third embodiment prompts removal of a non-overlapping commodity if there is no place to which to move the commodity 10 overlapping with another commodity. Therefore, the other features are indicated by the same symbols, and detailed description thereof is omitted.

Since the configuration of the checkout apparatus 1 of the third embodiment is the same as that of the second embodiment, description thereof is omitted.

Functions fulfilled by the processor 21 are described below. The functions described below are fulfilled by the processor 21 executing the program stored in the NVM 24, etc.

Also, if there is no place to which to move the overlapping commodity 10, the processor 21 functions to prompt removal of a non-overlapping commodity 10 (third article) and movement of the overlapping commodity 10 to a position on the placing stand 6.

The processor 21 generates a warning screen that is displayed on the placing stand 6 through the projector 8. The warning screen prompts a user to, for example, remove the non-overlapping commodity 10 and move the overlapping commodity 10. In this embodiment, the warning screen is an image that prompts removal of the non-overlapping commodity 10 and a sequence of images that prompts movement of the overlapping commodity 10.

The processor 21 generates, as the warning screen, a projection mapping image that is projected to the placing stand 6. For example, the processor 21 generates, as the warning screen, an animation, etc. in which the non-overlapping commodity 10 is removed and the overlapping commodity 10 is moved to a predetermined place.

The processor 21 displays the generated warning screen on the placing stand 6 through the projector 8.

The content of the warning screen is not limited to a specific configuration.

The processor 21 may also output, through the speaker 9, an audio message that prompts removal of the non-overlapping commodity 10 and movement of the overlapping commodity 10 to a position on the placing stand 6.

The processor 21 may also display, on the display 4, a message that prompts removal of the non-overlapping commodity 10 and movement of the overlapping commodity 10 to a position on the placing stand 6.

The processor 21 also functions to detect that the non-overlapping commodity 10 is removed and that the overlapping commodity 10 is moved to a position on the placing stand 6.

Upon projecting the warning screen, the processor 21 determines whether the non-overlapping commodity 10 is removed. For example, the processor 21 determines whether the commodity 10 is removed based on the captured image from the camera 3.

The processor 21 may also determine whether a user touches the commodity 10 based on the distance information. If determining that the user touches the commodity 10, the processor 21 determines that the commodity 10 is removed.

Upon determining that the commodity is removed, the processor 21 determines whether the overlapping commodity 10 is moved. For example, the processor 21 determines whether the commodity 10 is moved based on the captured image from the camera 3.

The processor 21 may also determine whether a user touches the commodity 10 based on the distance information. If determining that the user touches the commodity 10, the processor 21 determines that the commodity 10 is moved.

The processor 21 may also receive, from the user, an operation indicating that the non-overlapping commodity 10 is removed and that the overlapping commodity 10 is moved to a position on the placing stand 6, through the operation unit 5.

The method for the processor 21 to detect the removal and movement of each commodity 10 is not limited to a specific one.

An operation example in which the checkout apparatus 1 identifies a commodity is described below.

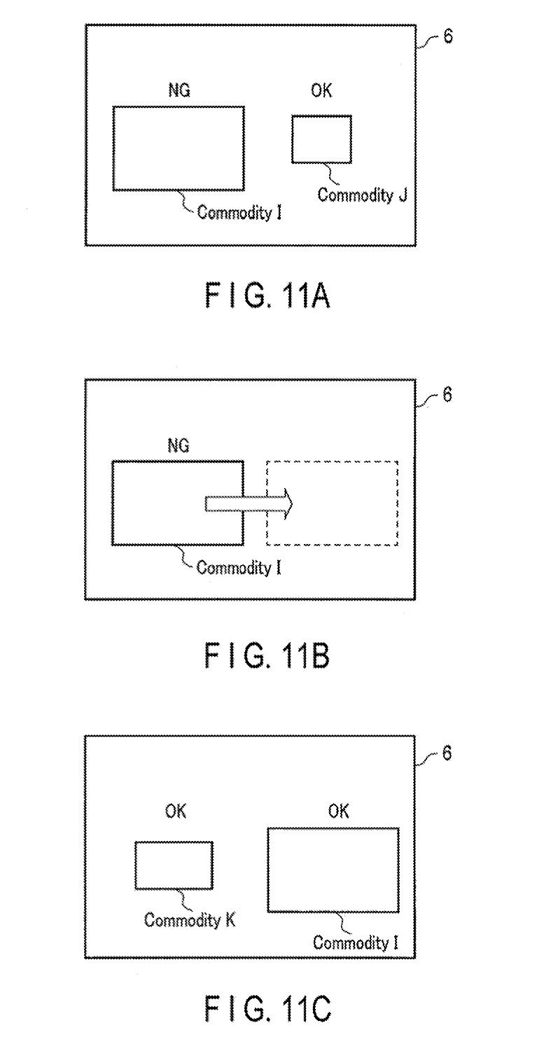

FIG. 11 is a diagram illustrating an operation example in which the checkout apparatus 1 identifies a commodity. In the example shown in FIG. 11, commodities I, J and K are placed on the placing stand 6. Also, the commodity I is placed on the commodity K.

First, the processor 21 of the checkout apparatus 1 identifies the commodities on the placing stand 6. In this example, the processor 21 identifies the commodities I and J, as shown in FIG. 11A.

The processor 21 determines that the commodity I overlaps another commodity (commodity K, in this example). Therefore, the processor 21 displays “NG” near the commodity I. The processor 21 displays, near the commodity J, “OK” indicating that the commodity J does not overlap with another commodity.

The processor 21 projects a warning screen that prompts removal of the commodity J and movement of the commodity I. In this example, a user removes the commodity J and moves the commodity I according to the warning screen.

The user moves the commodity I to the place where the commodity J used to be after removing the commodity J, as shown in FIG. 11B.

Upon detecting that the commodity J is removed and the commodity I is moved, the processor 21 identifies the commodities K and J. The processor 21 identifies the commodities K and J and displays “OK” near each commodity, as shown in FIG. 11C.

An operation example of the checkout apparatus 1 is described below.

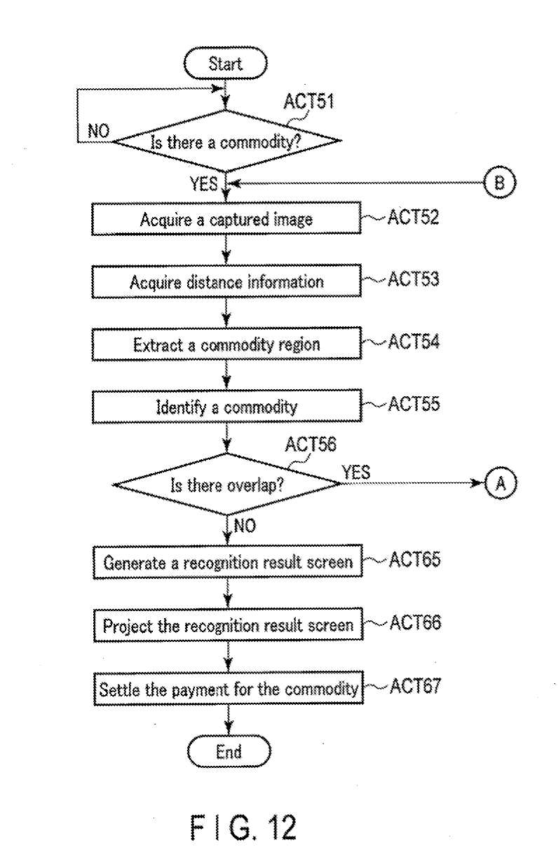

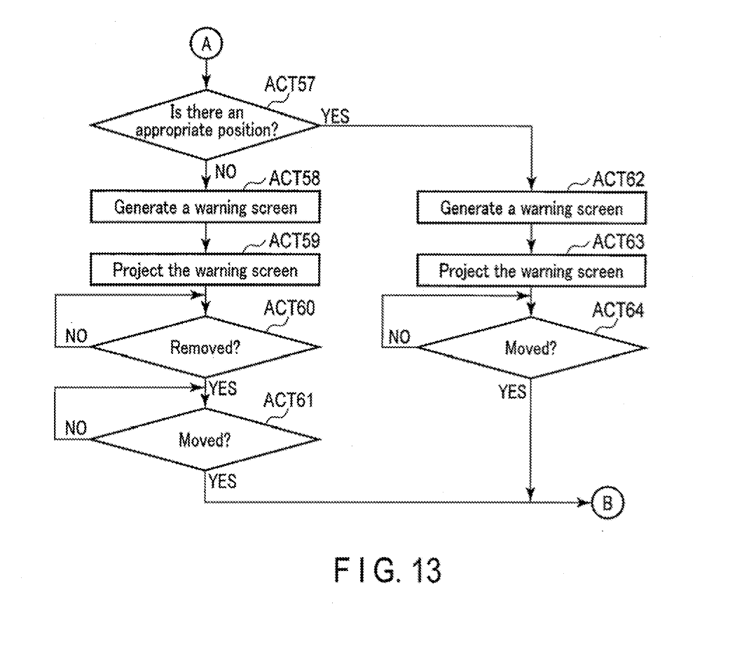

FIGS. 12 and 13 are flow charts illustrating an operation example of the checkout apparatus 1.

First, the processor 21 of the checkout apparatus 1 determines whether the commodity 10 is placed on the placing stand 6 (ACT 51). Upon determining that the commodity 10 is not placed on the placing stand 6 (ACT 51, NO), the processor 21 returns to ACT 51.

Upon determining that the commodity 10 is placed on the placing stand 6 (ACT 51, YES), the processor 21 acquires a captured image of the commodity 10 through the camera 3 (ACT 52). Upon acquiring the captured image, the processor 21 acquires distance information from the distance sensor 7 (ACT 53).

Upon acquiring the distance information, the processor 21 extracts a commodity region from the captured image (ACT 54). Upon extracting the commodity region, the processor 21 identifies the commodity 10 in the commodity region (ACT 55).

Upon identifying the commodity 10, the processor 21 determines whether the identified commodity 10 overlaps with another commodity (ACT 56). Upon determining that the identified commodity 10 overlaps with another commodity (ACT 56, YES), the processor 21 determines whether there is a place to which to move the identified commodity 10 (overlapping commodity 10) (ACT 57).

Upon determining that there is no place to which to move the identified commodity 10 (ACT 57, NO), the processor 21 generates a warning screen that prompts removal of the non-overlapping commodity 10 and movement of the overlapping commodity 10 (ACT 58). Upon generating the warning screen, the processor 21 projects the generated warning screen through the projector 8 (ACT 59).

Upon projecting the warning screen, the processor 21 determines whether the non-overlapping commodity 10 is removed (ACT 60). Upon determining that the non-overlapping commodity 10 is not removed (ACT 60, NO), the processor 21 returns to ACT 60. The processor 21 may keep projecting the warning screen.

Upon determining that the non-overlapping commodity 10 is removed (ACT 60, YES), the processor 21 determines whether the overlapping commodity 10 is moved (ACT 61). Upon determining that the overlapping commodity 10 is not moved (ACT 61, NO), the processor 21 returns to ACT 61. The processor 21 may keep projecting the warning screen.

Upon determining that the overlapping commodity 10 is moved (ACT 61, YES), the processor 21 returns to ACT 52.

Upon determining that there is a place to which to move the identified commodity 10 (ACT 57, YES), the processor 21 generates a warning screen that prompts movement of the identified commodity 10 (ACT 62).

Upon generating the warning screen, the processor 21 projects the generated warning screen onto the placing stand 6 through the projector 8 (ACT 63). Upon projecting the warning screen, the processor 21 determines whether the identified commodity 10 is moved (ACT 64).

Upon determining that the identified commodity 10 is not moved (ACT 64, NO), the processor 21 returns to ACT 64. The processor 21 may keep projecting the warning screen.

Upon determining that the identified commodity 10 is moved (ACT 64, YES), the processor 21 returns to ACT 52.

Upon determining that the identified commodity 10 does not overlap with another commodity (ACT 56, NO), the processor 21 generates a recognition result screen concerning the identified commodity 10 (ACT 65). Upon generating the recognition result screen, the processor 21 projects the generated recognition result screen onto the placing stand 6 through the projector 8 (ACT 66).

Upon projecting the generated recognition result screen onto the placing stand 6, the processor 21 settles the payment for the identified commodity 10 (ACT 67). Upon settling the payment for the identified commodity 10, the processor 21 ends the operation.

If there are a plurality of non-overlapping commodities 10, the processor 21 may prompt removal of some or all of the plurality of commodities. Also, if there are a plurality of overlapping commodities 10, the processor 21 may prompt movement of the plurality of commodities.

The article recognition apparatus need not be configured as the checkout apparatus 1. For example, the article recognition apparatus need not carry out settlement. The article recognition apparatus may be configured as a checking apparatus that recognizes an article, for example.

The checkout apparatus having the above-described configuration removes a non-overlapping commodity to identify a commodity if there is no place to which to move a commodity on the placing stand. Accordingly, the checkout apparatus can identify a commodity without removing an overlapping commodity and placing the commodity again. As a result, the checkout apparatus can identify a commodity more quickly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An article recognition apparatus that recognizes an article, the apparatus comprising:
an image interface that acquires a captured image of a placing area where an article is placed; and
a processor that:
acquires a captured image through the image interface;
identifies a first article from the captured image;
determines whether the first article overlaps a second article;
if determining that the first article overlaps the second article, displays on a display device a warning screen that prompts movement of the first article to a position where the first article does not overlap another article;
determines whether the first article is moved; and
upon determining that the first article is moved, acquires a captured image through the image interface and identifies one or more articles from the captured image.

2. The article recognition apparatus according to claim 1, comprising a distance information interface that acquires distance information indicating a distance from the placing area,
wherein the processor:
acquires an outer size set to the first article;
calculates a height of the first article based on the distance information; and
if the outer size and the height do not match each other, determines that the first article overlaps the second article.

3. The article recognition apparatus according to claim 1, wherein the display device is a projector, wherein the processor displays a warning screen that prompts movement of the first article to a position where the first article does not overlap with another article, to the placing area through the projector.

4. The article recognition apparatus according to claim 3, wherein the warning screen is an animation that prompts movement of the first article to a position where the first article does not overlap with another article.

5. The article recognition apparatus according to claim 1, wherein the processor:
if determining that the first article overlaps the second article, determines whether there is a place to which to move the first article where the first article does not overlap with another article in the placing area; and
upon determining that there is no place to which to move the first article, displays on the display device a warning screen that prompts removal of the first article.

6. The article recognition apparatus according to claim 1, wherein the processor:
if determining that the first article overlaps the second article, determines whether there is a place to which to move the first article where the first article does not overlap with another article in the placing area; and
upon determining that there is no place to which to move the first article, displays on the display device a warning screen that prompts removal of a non-overlapping third article and movement of the first article.

7. The article recognition apparatus according to claim 1, comprising a camera that captures the image of the placing area.

8. The article recognition apparatus according to claim 3, comprising the projector.

9. An article recognition method for recognizing an article, the method comprising:
acquiring a captured image of a placing area where an article is placed;
identifying a first article from the captured image;
determining whether the first article overlaps a second article;
if determining that the first article overlaps the second article, displays on a display device a warning screen that prompts movement of the first article to a position where the first article does not overlap another article;
determining whether the first article is moved; and
upon determining that the first article is moved, acquiring a captured image and identifying one or more articles from the captured image.

10. A non-transitory readable storage medium comprising a program that causes a processor to:
acquire a captured image of a placing area where an article is placed;
identify a first article from the captured image;
determine whether the first article overlaps a second article;
if determining that the first article overlaps the second article, display on a display device a warning screen that prompts movement of the first article to a position where the first article does not overlap another article;
determine whether the first article is moved; and
upon determining that the first article is moved, acquire a captured image and identify one or more articles from the captured image.
